(19) United States
(12) Patent Application Publication
(10) Pub. No.: US 2020/0245568 A1
(43) Pub. Date: Aug. 6, 2020

(54) Method to prevent the formations of Hurricanes and Typhoons by reducing the Surface-temperature of the Oceans

(71) Applicants: Hideo Tomomatsu, Escondido, CA (US); Tadao Tomomatsu, Escondido, CA (US)

(72) Inventors: Hideo Tomomatsu, Escondido, CA (US); Tadao Tomomatsu, Escondido, CA (US)

(21) Appl. No.: 16/350,908

(22) Filed: Feb. 1, 2019

(51) Int. Cl. A01G 15/00

(52) U.S. Cl. CPC A01G 15/00

(57) ABSTRACT

The formation mechanisms of devastating Hurricanes and Typhoons in the Northern Equator were analyzed.

These Hurricanes and Typhoons have taken lives, property and devastation to the environment.

We created a solution to save lives and the environmental effects.
Hurricanes and Typhoons were found to form by the following two mechanisms:
Mechanism (I): “High Sea-Surface Temperatures” along the Equator zone.
Mechanism (II): “Anti-Clock-Wise Strong Westward Winds” along the Equator zone.
We can prevent Mechanism (I). Various experiments were performed to prevent Mechanism (I).
Results: spraying sea-water above the forming zone for about 20 min. reduces the Sea-surface temperature to 15.0° and prevents formations of Hurricanes and Typhoons.
Also, as the best way to carry-out this process, is to find the high temperature zones by helicopters or drones equipped with Infrared-thermometers and guide Fireboat-fleets to the location even before the formations of Hurricanes and Typhoons.

### BACKGROUND OF THE INVENTION

As we started to realize now, our careless formation of too-much carbon dioxide (CO2) is polluting the Earth's atmosphere causing temperature-rises in both oceans and lands. The malignant effects have been and are appearing rather quickly in recent days.

The worst phenomena of this situation are the formations of the Hurricanes and Typhoons being formed around the Equator.

These extremely low atmospheric-pressures being formed around at the Equator as Hurricanes (so called in Atlantic Ocean) and Typhoons (so called in the Pacific Ocean), are causing tremendous loss of life of residents and huge damages to the Lands by the extremely heavy rainfalls and strong winds causing many land-slides and tremendous floods.

The frequencies of the distresses have been increasing recently, and the Typhoons have formed already 26 times in the ten-months this year after January 2018 and attacked the Southeast Asia and the Far-East causing tremendous damages by their heavy-rains and strong-winds.

Also, in the Atlantic Ocean, two big Hurricanes (of 8 hurricanes and 15 storms) have attacked this year the Eastern Seaboards of the United States: Southern states, Puerto Rico, South Carolina, and Florida giving serious floods and heavy wind-damages.

### THE FORMATION MECHANISMS OF TYPHOONS AND HURRICANES

We investigated the formation mechanisms of Typhoons and Hurricanes at around the Northern-side of the Equator and found that they are formed by the following two key mechanisms.

Mechanism (I):

Unusually-high Sea-Surface-Temperature in the Equatorial-Ocean due to the strong sunlight in daytimes, especially in the summers and falls, (recently even in December), causes the rapid evaporation of the Ocean's surface-water forming the tall and heavy clouds of Typhoons and Hurricanes above the area.

Mechanism (II):

Making the situation worse, winds are always blowing strongly to the West-direction at immediately North-side of the Equator due to the Earths' Rotation.

This strong Anti-clock-wise winds will rotate the heavy and tall clouds formed by the Mechanism (I), and built-up the viciously strong low-pressured Hurricanes and Typhoons.

[Note 1] The winds formed by Mechanism (II) will become simple “Seasonal Trade Breezes,” if we prevent the formations of the Typhoons and Hurricanes by solving the problem of Mechanism (I).

[Note 2] At the further north-side of the Equator, namely at the “Tropic of Cancer” area, there is no appreciable Westward winds are existing due to the much lesser effect of the Earths' Rotation.

[Note 2] Fortunately, the winds of Clock-Wise Air Circulations similarly forming in the South-side of Equator by the Earth's Rotation, are being offset by the westward wind of the Earth's Rotation, and usually they don't contribute to the formations of Typhoons and Hurricanes in the South-side of the Equator.

For Preventing the Formations of Typhoons and Hurricanes

Based on the data described above, we, the inventors of this patent theorized that;
“By cooling the very high Sea-surface-temperature,” then
“We can prevent the formations of Hurricanes and Typhoons.”

We can Save Lives and Improve the stabilization of the Environment and property.

It is because, by solving Mechanism (1) by cooling the Sea-surface, we can solve the Mechanism (II) simultaneously, due to the disappearances of the tall and heavy hurricane/typhoon clouds.

Various Methods to Cool Sea-Surface-Temperature

As the methods to cooling-down the sea-surface-temperature of the Typhoons and Hurricanes forming zones of the Ocean, there are several ways to achieve it.

For examples, stirring the Ocean-surface mechanically by screws or by bubbling air using speed-boats, helicopters, drones or covering the area with floatable materials as floating Solar-panels, or dumping oils, floating powders to prevent the heat-transfer from ocean-surface to air, etc.

The Best Method is to Shoot or Spray(ing) Sea-Water on the Warm Ocean Surfaces

However, the inventors of this patent discovered that shooting or spraying sea-water above the Typhoon and Hurricane forming zones is a very effective, low-cost and convenient methods to cool-down the high surface-temperature of zones with many successful experiments as described below.

The shooting or spraying sea-water (or water) have an additional advantage that the splayed or shooting sea-mist (or water) particles to the high altitude, will aggregates the storm cloud-particles to rain-falls, which will eliminate the storm clouds and at the same time, will reduce further the Ocean-surface-temperature. And the potentiality of Typhoons/Hurricanes.

The Successful Experiments of Cooling Sea-Surface-Temperature by Shooting or Spraying Water

The inventors of this patent discovered that the shooting or spraying water can quite effectively reduce the surface-temperatures at about 20 min. by various experiments as shown below.

### EXAMPLE I

Using a remote-controlled Weather-Station “AcuRite” (model 02016/02040), the ground-level temperature changing was observed for the period of 30 min. by spraying water into the above-space of the “AcuRite” on the ground.

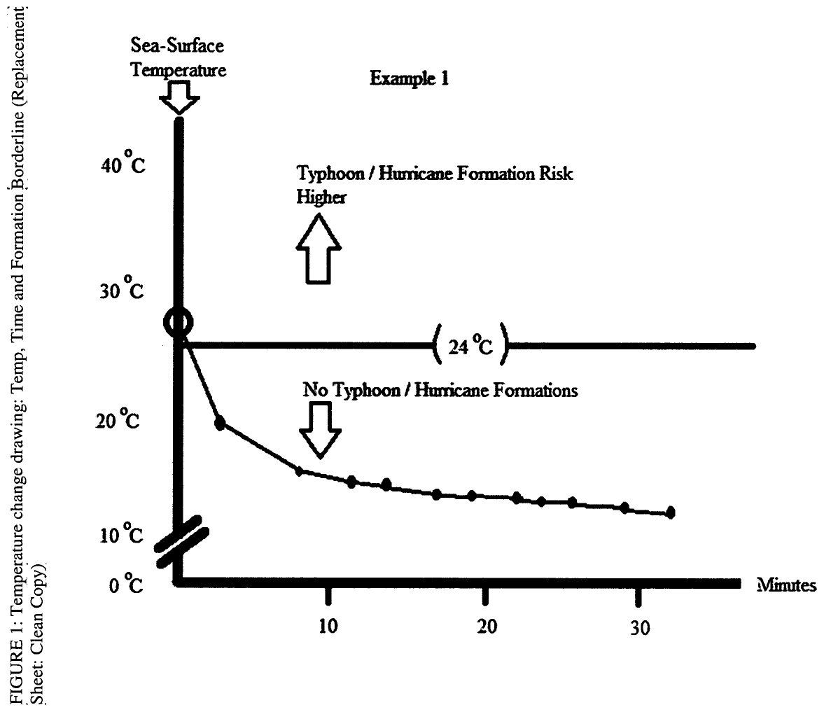

It gave the following excelled cooling-result.

[FIG. 1.] (Figure(s) in Graphics Section following “claims”)

Ground-level temperature changes by spraying water.

The surface-temperature decrement of from 25.6° C. to 15.0° C. (namely—10.6° C.) is enough to annihilate the formations of Typhoons and Hurricanes formations in the Equatorial zone.

It is because the reported highest-surface-temperature in the immediately north-side of the Equator is 30° C., and the reported temperature at the “Tropic of Cancer” in which Typhoon/Hurricane formations does not happen at 24° C. [Ref. 1 and 2] (Reverse can be said for “Tropic of Capricorn” areas)

This can be schematically expressed as below.

Namely:

| Typhoon/Hurricane formation Temperature: | 30° C. | |
|---|---|---|
| (“Equator” area) | | |
| Typhoon/Hurricane non-formation Temperature; | 24° C. | |
| (“Tropic of Cancer” area) | | |
| Cooled Sea-surface | | |
| by Spraying sea-water | {close oversize brace} | 15° C.-(Over-cooled) |
| (No Typhoons/Hurricanes at 15° C.) | | |

Thus, the storm-forming Equatorial surface-temperature (30° c. in October 2018) is only 6.0° C. higher than the non-storm-forming temperature in the “Tropic of Cancer” (24° C.) even in October 2018.

Therefore, this Example I which was cooled to 15.0° C. is showing that the technology of the spraying sea-water has more than enough ability to annihilate Hurricanes and Typhoons.

It should be noted that, the thicknesses of the warm Sea-surface are reported to be only less than 2 inches (6 cm). [Ref. 1 and 2] Partly cited from JPL (Jet Propulsion Laboratory), Global, Dec. 20, 2013, and the “Weather Forecast” by Mr. Toshiyuki Minami of NHK (Japan Broadcasting Association), Nov. 9, 2018.

### Example II

This Example II was carried-out on a clear warm day on Nov. 20, 2018 in California.

The initial ground-surface temperature was 30° C.

However, after started spraying water, the Ground-level temperature was reduced to the same 15° C. as the Example I.

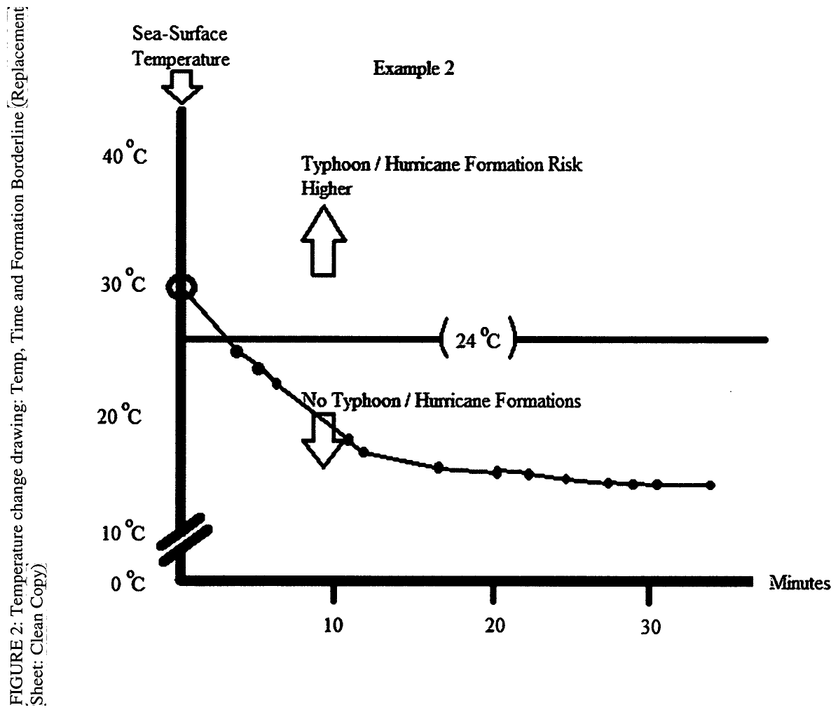

It is important to realize that the spraying-water technology gives the same type of the curve to reach the same ground-temperature of 15° C.

[FIG. 2] (Figure(s) in Graphics Section following “claims”)

Ground-level temperature changes form 30° C.

### Example III

This Example III was carried-out a partly cloudy day.

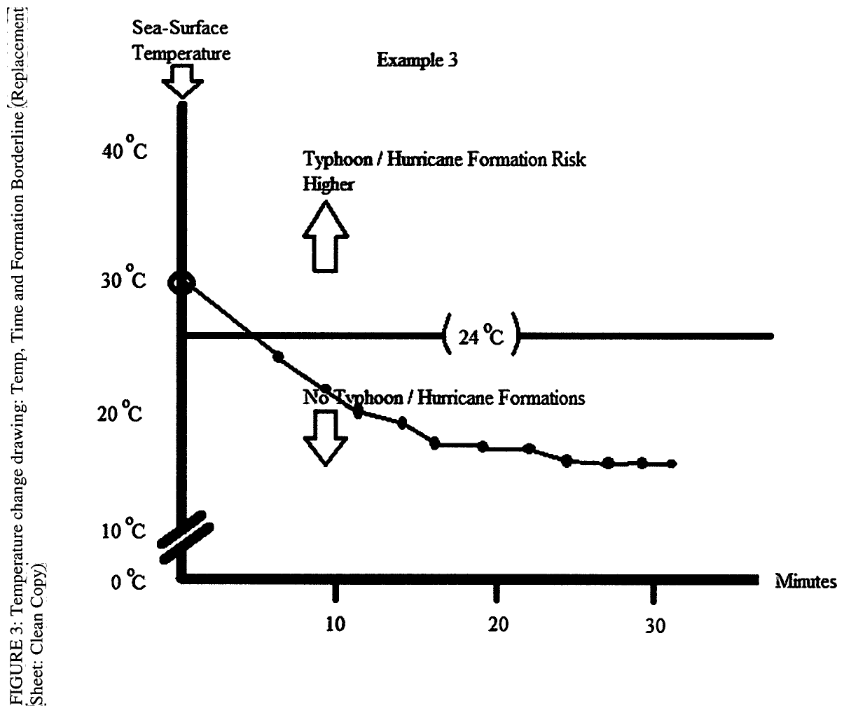

The ground-level temperature 15° C. was attained by the same pattern of the temperature decrease.

[FIG. 3] (Figure(s) in Graphics Section following “claims”)

Ground-level temperature reduction to 15° C.

### Example IV

This Example IV was carried-out relatively cool cloudy day.

The starting ground-level temperature was only 23° C.

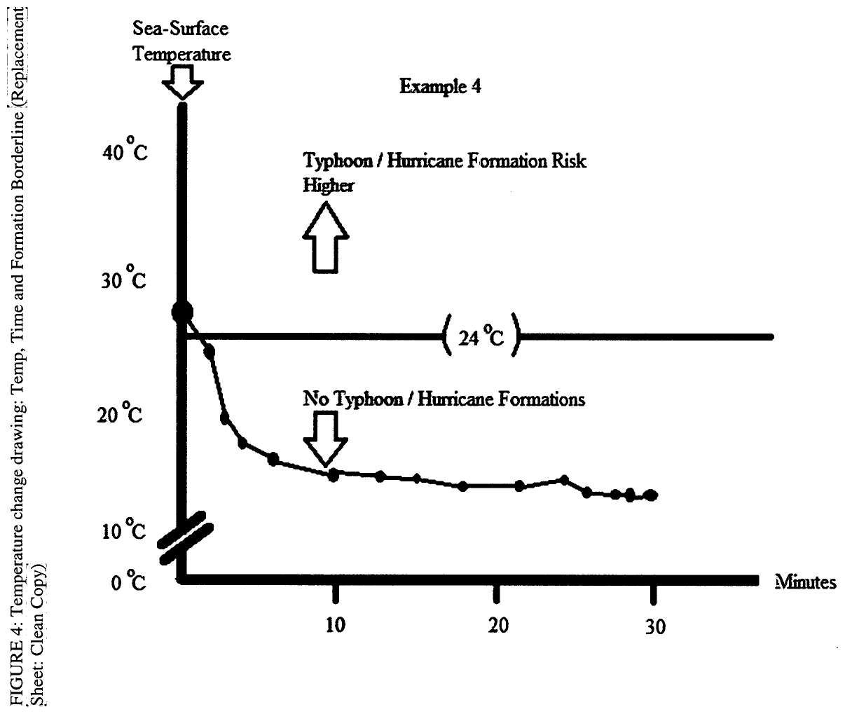

However, after starting the water-spray, the ground-level temperature started to decrease by the usual pattern and reached to 15° C.

[FIG. 4] (Figure(s) in Graphics Section following “claims”)

Ground-temperature reduction from relatively low temperature of 23° C.

The Most Efficient Tornado Annihilation System: Infrared-Thermometer Equipped Helicopters/Drones+Fireboat Fleets

Ideally, the most efficient Typhoons and Hurricanes annihilation system is, firstly finding high temperature Sea-surface zones by helicopters/drones equipped Infrared-thermometer with laser-beam, and guide Fireboats-Fleet to the locations to cool-down the high Sea-surface temperature zones, even before hurricane/typhoon clouds start to form.

By this new technology, the Earth might become the better place to live for the all livings.

We claim:

1. A method to prevent the formation of Hurricanes and Typhoons by reducing the surface-temperature of the storm forming area of the Oceans.

2. A method that will materially enhance the quality of the Environment of mankind by contributing to the restoration or maintenance of basic life sustaining natural elements. By preventing the formation of Hurricanes and Typhoons we will be reducing of loss of lives, destruction of natural elements and property in these types of disaster and related collateral disasters. Such as floods, storms, wild-fires, etc.

3. A method to prevent the formation of Hurricanes and Typhoons by reducing the surface-temperature of the storm forming area of the Oceans as in claim 1 wherein the surface-temperature of the Ocean area is reduced by spraying sea water or water over the storm forming or appears to be storm forming area.

4. A method to prevent the formation of Hurricanes and Typhoons by reducing the surface-temperature of the storm forming area of the Oceans as in claim 1 wherein the surface-temperature of the Ocean area is reduced via mechanical or ultra-sonic devices by stirring, misting or by air-bubbling.

5. A method to prevent the formation of Hurricanes and Typhoons by reducing the surface-temperature of the storm forming area of the Oceans as in claim 1 wherein the surface-temperature of the Ocean area is reduced by driving several slow or high-speed boat(s).

6. A method to prevent the formation of Hurricanes and Typhoons by reducing the surface-temperature of the storm forming area of the Oceans as in claim 1 wherein the surface temperature of the Ocean area is reduced by stirring with the strong downward air-pressures of helicopters/drones or other flying air-type vehicles: suspended or otherwise.

7. A method to prevent the formation of Hurricanes and Typhoons by reducing the surface-temperature of the storm area of the Oceans as in claim 1 wherein the surface temperature of the Ocean area is reduced by dumping or dropping liquids from helicopters/drones or other flying air-type vehicles: suspended or otherwise.

8. A method to prevent the formation of Hurricanes and Typhoons by reducing the surface-temperature of the storm forming area of the Oceans as in claim 1 wherein the surface temperature of the Ocean area is reduced by covering the sea surface by sun-light shielding materials such as many Solar-panels, the energy attained from which is useable to drive the stirring panels under the surface-water for the further cooling of the surface-water.

9. A method to prevent the formation of Hurricanes and Typhoons by reducing the surface-temperature of the storm forming area of the Oceans as in claim 1 wherein non-evaporative light weight particles or film-forming oily liquids are utilized, though there are serious pollution issues.

10. A method to prevent the formation of Hurricanes and Typhoons by reducing the surface-temperature of the storm forming area of the Oceans as in claim 1 wherein the high Sea-surface temperature zones are discovered by boats, helicopters or drones equipped with Infrared-thermometers.

11. A method to prevent the formation of Hurricanes and Typhoons by reducing the surface-temperature of the storm forming area of the Oceans as in claim 1 wherein the Fireboat-Fleets are effectively guided by boats, helicopters or drones equipped with Infrared-thermometers to high Sea-surface temperature zones.
GRAPHICS SECTION: All “FIGURE” Graphs
